(19) United States
(12) Patent Application Publication
(10) Pub. No.: US 2026/0140013 A1
(43) Pub. Date: May 21, 2026

(54) METHOD AND DEVICE FOR GENERATING A DARK-FIELD INSPECTION IMAGE OF AN OPHTHALMIC LENS

(71) Applicant: Alcon Inc., Fribourg (CH)

(72) Inventors: Daniel ENGLISCH, Rodenbach (DE); Jochen KOEHLER, Aschaffenburg (DE); Sandra KRAUS, Niedernberg (DE)

(21) Appl. No.: 19/392,537

(22) Filed: Nov. 18, 2025

Related U.S. Application Data
(60) Provisional application No. 63/722,362, filed on Nov. 19, 2024.

(51) Int. Cl. G01M 11/02; G02C 13/00; G06T 7/00; H04N 23/71; H04N 23/74

(52) U.S. Cl. CPC G01M 11/0257; G02C 13/003; G06T 7/0002; H04N 23/71; H04N 23/74; G06T 2207/10152; G06T 2207/20212

(57) ABSTRACT

A method for generating a dark-field inspection image of an ophthalmic lens includes acquiring at least a first dark-field image, a second dark-field image, and a third dark-field image of the ophthalmic lens, determining a brightness value of each pixel of the at least first, second, and third dark-field images, comparing the determined brightness value of each corresponding pixel of the at least first, second, and third dark-field images and determining for each of the corresponding pixels a lowest brightness value, and generating the dark-field inspection image by setting the brightness value of a pixel of the dark-field inspection image to a brightness value representative of a dark pixel in case the determined lowest brightness value is representative of a dark pixel, otherwise setting the brightness value of the pixel of the dark-field inspection image to a brightness value representative of a bright pixel.

### CROSS-REFERENCE TO RELATED APPLICATIONS

This application claims the benefit of U.S. Provisional Application No. 63/722,362, filed Nov. 19, 2024, which is incorporated herein by reference in its entirety.

### FIELD

The present disclosure relates to a method and a device for generating a dark-field inspection image of an ophthalmic lens, in particular an intraocular lens.

### BACKGROUND

Ophthalmic lenses such as intraocular lenses are inspected, among others, for the presence of unacceptable defects prior to being delivered to the customers. An intraocular lens typically comprises a lens body that is bounded by an edge, and two haptics attached to the lens body. In particular, the lens body must be carefully inspected for the presence of unacceptable defects, as the lens is subsequently implanted in the user's eye (e.g. during cataract surgery). Inspection of the lens body of an intraocular lens for unacceptable defects is often performed using automated lens inspection equipment for capturing images of the intraocular lens and for image analysis of the captured images.

Certain types of defects that scatter light (like e.g. scratches, fissures, edge defects, etc.) are well visible in a dark-field image of the intraocular lens. With increasing diopter (D) of the intraocular lens, however, imaging artifacts (reflections of the light source) may appear in the dark-field image as bright or white areas. As a consequence, any defects present within those bright or white areas may not be reliably detected.

A solution for generating a dark-field inspection image of intraocular lenses with mid diopters (e.g. 8 D to 32 D) has been proposed where the illumination of an intraocular lens is provided by a circular arrangement of light-emitting diodes (LEDs). Twelve groups of LEDs each comprising two closely arranged LEDs are circularly arranged at an angular distance of thirty degrees between adjacent groups. Adjacent groups of LEDs are alternately assigned to a first set and a second set of LEDs. That is to say, along the circular arrangement of LEDs each group of two LEDs assigned to the first set is followed by a group of two LEDs assigned to the second set, which is again followed by a group of two LEDs assigned to the first set, and so on.

Two dark-field images of the intraocular lens are consecutively acquired, a first dark-field image of the intraocular lens illuminated by the first set of LEDs only, and a second dark-field image illuminated by the second set of LEDs only. A dark-field inspection image is then generated by setting the brightness value of each pixel of the dark-field inspection image to the lowest brightness value of the corresponding pixel of the first and second dark-field images.

During inspection of intraocular lenses with higher diopters (e.g. 33 D and more), in addition to the afore-mentioned imaging artifacts (first order artifacts) further imaging artifacts (so-called second order imaging artifacts) may appear in the dark-field image as a bright or white area, typically in a region near the edge of the lens body of the intraocular lens. Such second order imaging artifacts do, however, overlap in some regions of both the first and the second dark-field images. Therefore, the dark-field inspection image comprises bright or white areas corresponding to these overlapping regions of the second order imaging artifacts, so that defects present within these regions may not be reliably detected.

It is therefore an object of the present disclosure to overcome the afore-mentioned disadvantages, and in particular allow inspection, including dark-field image inspection, of ophthalmic lenses, in particular intraocular lenses, within a broad range of diopters including higher diopters (i.e. 33 D and more), which do not suffer from the afore-mentioned disadvantages.

### SUMMARY

The present disclosure suggests a method for generating a dark-field inspection image of an ophthalmic lens, in particular an intraocular lens, and comprises the steps of: acquiring at least a first dark-field image, a second dark-field image and a third dark-field image of the ophthalmic lens, in particular the intraocular lens, wherein when acquiring the at least first dark-field image, the second dark-field image and the third dark-field image, the ophthalmic lens, in particular the intraocular lens, is consecutively illuminated by a corresponding different one of at least a first set, a second set and a third set, respectively, of light-emitting elements of a light source, wherein each light-emitting element of the light source is assigned to only one set of the at least first set, the second set and the third set of light-emitting elements, and wherein the light-emitting elements are arranged along a circle with an angular distance between two non-adjacently arranged light-emitting elements that is larger than the angular size of imaging artifacts of any of the at least first dark-field image, the second dark-field image and the third dark-field image, so that imaging artifacts of at least one of the at least first dark-field image, the second dark-field image and the third dark-field image do not overlap with imaging artifacts of at least one other dark-field image of the at least first dark-field image, the second dark-field image and the third dark-field image; determining a brightness value of each pixel of the at least first dark-field image, the second dark-field image and the third dark-field image; comparing the determined brightness value of each corresponding pixel of the at least first dark-field image, the second dark-field image and the third dark-field image, and determining for each of the corresponding pixels of the at least first dark-field image, the second dark-field image and the third dark-field image a lowest brightness value; and generating the dark-field inspection image by setting the brightness value of a respective pixel of the dark-field inspection image to a brightness value representative of a dark pixel in case the determined lowest brightness value of a corresponding pixel of any of the at least first dark-field image, the second dark-field image and the third dark-field image is representative of a dark pixel, otherwise setting the brightness value of the respective pixel of the dark-field inspection image to a brightness value representative of a bright pixel.

According to one aspect of the method according to the present disclosure, the angular distance between two non-adjacently arranged light-emitting elements is at least 20°.

According to a further aspect of the method according to the present disclosure, the brightness value of the respective pixel of the dark-field inspection image which is representative of a dark pixel is set to the lowest brightness value determined for the corresponding pixel in any of the at least first dark-field image, the second dark-field image and the third dark-field image.

According to still a further aspect of the method according to the present disclosure the light-emitting elements of the at least first set, the second set and the third set of light-emitting elements are evenly spaced from one another along the circle.

According to yet a further aspect of the method according to the present disclosure, the light-emitting elements assigned to the at least first set, the second set and the third set of light-emitting elements are alternately arranged along the circle, i.e. along the circle each light-emitting element assigned to the first set is followed by a light-emitting element assigned to the second set which is followed by a light-emitting element of the third set, and so on.

According to a further aspect of the method according to the present disclosure, the actual number of the at least three dark-field images is an integer divisor larger than two of the total number of light-emitting elements arranged along the circle.

According to yet another aspect of the method according to the present disclosure, the light source comprises a total number of twenty-four light-emitting elements arranged at an angular distance of fifteen degrees between adjacently arranged light-emitting elements.

The present disclosure also suggests a device for generating a dark-field inspection image of an ophthalmic lens, in particular an intraocular lens, the device comprising: an image acquisition module for acquiring dark-field images of the ophthalmic lens, in particular the intraocular lens; a light source comprising a plurality of light-emitting elements for illuminating the ophthalmic lens, in particular the intraocular lens, wherein each light-emitting element of the light source is assigned to only one set of at least a first set, a second set and a third set of light-emitting elements, and wherein the light-emitting elements of the at least first set, the second set and the third set of light-emitting elements are arranged along a circle; a control unit configured to: control the image acquisition module to acquire at least a first dark-field image, a second dark-field image and a third dark-field image of the ophthalmic lens, in particular the intraocular lens, wherein, when acquiring a respective one of the at least first dark-field image, the second dark-field image and the third dark-field image, the control unit is further configured to operate only a corresponding different one of the at least first set, the second set and the third set, respectively, of the light-emitting elements of the light source to illuminate the ophthalmic lens, in particular the intraocular lens, wherein the light-emitting elements are arranged along the circle with an angular distance between two non-adjacently arranged light-emitting elements that is larger than the angular size of imaging artifacts of any of the at least first dark-field image, the second dark-field image and the third dark-field image, so that imaging artifacts of at least one of the first dark-field image, the second dark-field image and the third dark-field image do not overlap with imaging artifacts of at least one other dark-field image of the first dark-field image, the second dark-field image and the third dark-field image; and an image processing unit configured to: determine a brightness value of each pixel of the at least first dark-field image, the second dark-field image and the third dark-field image; compare the determined brightness value of each corresponding pixel of the at least first dark-field image, the second dark-field image and the third dark-field image, and determine for each of the corresponding pixels of the first dark-field image, the second dark-field image and the third dark-field image a lowest brightness value; and generate the dark-field inspection image by setting the brightness value of a respective pixel of the dark-field inspection image to a brightness value representative of a dark pixel in case the determined lowest brightness value of a corresponding pixel of any of the at least first dark-field image, the second dark-field image and the third dark-field image is representative of a dark pixel, otherwise setting the brightness value of the respective pixel of the dark-field inspection image to a brightness value representative of a bright pixel.

According to one aspect of the device according to the present disclosure, the angular distance between two non-adjacently arranged light-emitting elements is at least 20°.

According to another aspect of the device according to the present disclosure, the image processing unit is further configured to set the brightness value of the respective pixel of the dark-field inspection image which is representative of a dark pixel to the lowest brightness value determined for the corresponding pixel in any of the at least first dark-field image, the second dark-field image and the third dark-field image.

According to still a further aspect of the device according to the present disclosure, the light-emitting elements of the at least first set, the second set and the third set are arranged evenly spaced from one another along the circle.

According to yet a further aspect of the device according to the present disclosure, the light-emitting elements assigned to the at least first set, the second set and the third set of light-emitting elements are alternately arranged along the circle, i.e. along the circle each light-emitting element assigned to the first set is followed by a light-emitting element assigned to the second set which is followed by a light-emitting element of the third set, and so on.

According to another aspect of the device according to the present disclosure, the control unit is configured to control the image acquisition module to acquire an actual number of the at least three dark-field images which is an integer divisor larger than two of the total number of light-emitting elements arranged along the circle.

According to still another aspect of the device according to the present disclosure, the light source comprises a total number of twenty-four light-emitting elements arranged at an angular distance of fifteen degrees between adjacently arranged light-emitting elements.

According to yet another aspect of the device according to the present disclosure, the light-emitting elements comprise LEDs, and each light-emitting element comprises a single LED only.

The method and the device of the present disclosure have several advantages. First of all, the method and the device of the present disclosure allow for inspection of ophthalmic lenses, in particular intraocular lenses, within a broad range of diopters without suffering from the drawbacks known from prior solutions. Accordingly, with a method and a device of the present disclosure, a dark-field inspection image of an ophthalmic lens, in particular an intraocular lens, can be generated without imaging artifacts. To achieve this, at least three (i.e. three or more) dark-field images of the ophthalmic lens are acquired, namely a first dark-field image, a second dark-field image and a third dark-field image. In the case of three dark-field images and three sets of light-emitting elements (this case being discussed in the following by way of example), the first, second and third dark-field image is acquired by illuminating the ophthalmic lens, in particular the intraocular lens, with the first set, the second set and the third set of light-emitting elements of the light source, with each light-emitting element of the light source being assigned to only one of the first set, the second set and the third set of light emitting elements. Through the arrangement of the light-emitting elements of the light source along a circle with an angular distance between two non-adjacently arranged light-emitting elements that is larger than the angular size of imaging artifacts, imaging artifacts which may be present in one of the first, second and third dark-field images do not overlap with imaging artifacts of at least one other of the first, second and third dark-field images. The dark-field inspection image is generated by first determining brightness values of the pixels of the first, second and third dark-field images. If the brightness value of a corresponding pixel in any of the first, second and third dark-field images is representative of a dark pixel, then the brightness value of the respective pixel of the dark-field inspection image is set to a brightness value representative of a dark pixel. Otherwise, the respective pixel of the dark-field inspection image is set to a brightness value representative of a bright pixel. More frankly speaking, this means that in case a particular pixel is ‘dark’ in any of the first, second and third dark-field images, the corresponding pixel in the dark-field inspection image is set to ‘dark’. Otherwise, the particular pixel is ‘bright’ in all of the first, second and third dark-field images, and the corresponding pixel in the dark-field inspection image is set to ‘bright’. Thus, the dark-field inspection image can be generated which is free of imaging artifacts. Corresponding considerations hold in case more than three sets of light-emitting elements are provided, and consequently a corresponding number of dark-field images larger than three is acquired and evaluated in the same manner.

An angular distance of at least 20° (i.e. 20°or more) between two non-adjacently arranged light emitting elements is sufficient to achieve the afore-described result, i.e. a dark-field inspection image free of imaging artifacts.

Setting the brightness value of a respective pixel of the dark-field inspection image can be easily performed by just setting the respective pixel of the dark-field inspection to the lowest brightness value of the corresponding pixel of the (at least) first, second and third dark-field images. However, in general the brightness value of the respective pixel in the dark-field inspection image can be determined in other ways, too, as longs as the brightness value is representative of the correct brightness level (i.e. dark or bright).

Evenly spacing the light-emitting elements of the first set, the second set and the third set of light-emitting elements along the circle is advantageous, since with such an arrangement, overlapping of the imaging artifacts of the first, second and third dark-field image can be minimized.

The actual number of dark-field images (three or more) may be an integer divisor larger than two of the total number of light-emitting elements. For example, the total number of light-emitting elements may be thirty-six (which may be arranged evenly distributed along the circle, one every ten degrees). The number of dark-field images may then be three, four, six, nine, twelve or eighteen (theoretically even thirty-six). In another example, the total number of light-emitting elements may be thirty (evenly distributed along the circle, one every twelve degrees). The number of dark-field images may then be three, five, six, ten, or fifteen (theoretically even thirty). As another example, the total number of light-emitting elements may be twenty-four (evenly distributed along the circle, one every fifteen degrees). The number of dark-field images may then be three, four, six, eight or twelve (theoretically even twenty-four).

The use of LEDs as the light-emitting elements is advantageous as LEDs are small and comparatively inexpensive components which are readily available on the market.

Suitable image acquisition modules are also readily available on the market and may (or may not) be provided with an image processing unit that needs to be programmed accordingly to perform the afore-mentioned evaluation and generation of the dark-field inspection image. The control unit and/or the image processing unit may be also implemented separately or may be integrated into a single device or within a hierarchically higher lever controller which may also have additional functions for controlling the device.

### BRIEF DESCRIPTION OF THE DRAWINGS/FIGURES

The accompanying drawings, which are incorporated herein and form part of the specification, illustrate the embodiments and, together with the description, further serve to explain the principles of the embodiments and to enable a person skilled in the relevant art(s) to make and use the embodiments. Further advantageous aspects of the method of the present disclosure may become apparent from the following description of embodiments with the aid of the schematic drawings in which:

FIG. 1 shows a light source according to a known solution;

FIG. 2 shows a dark-field image of an intraocular lens illuminated by the light source of FIG. 1;

FIG. 3 shows imaging artifacts still present in a dark-field inspection image of an ophthalmic lens generated according to known solutions;

FIG. 4 shows an embodiment of a light source used in some exemplary embodiments;

FIG. 5 shows a first dark-field image of an intraocular lens illuminated by a first set of light-emitting elements of the light source of FIG. 4;

FIG. 6 shows a second dark-field image of the intraocular lens illuminated by a second set of light-emitting elements of the light source of FIG. 4;

FIG. 7 shows a third dark-field image of an ophthalmic lens illuminated by a third set of light-emitting elements of the light source of FIG. 4;

FIG. 8 shows a dark-field inspection image of an intraocular lens generated in accordance with some exemplary embodiments; and

FIG. 9 shows an embodiment of a device for generating a dark-field inspection image of an intraocular lens according to some exemplary embodiments.

### DETAILED DESCRIPTION

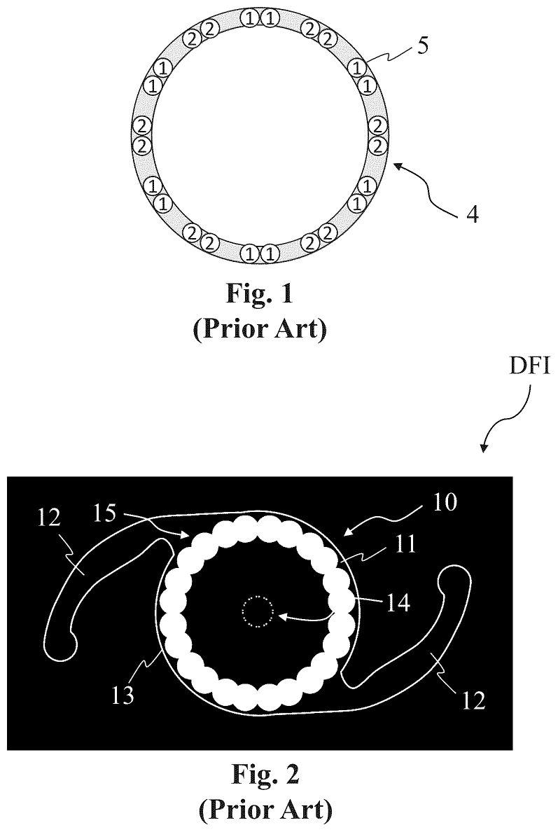

FIG. 1 shows a light source 4 according to a known solution. The light source 4 comprises a circular arrangement of twenty-four LEDs 5, of which only one is labelled with a reference numeral for the sake of simplicity. The LEDs 5 are arranged in twelve groups of LEDs 5, each group comprising two closely arranged LEDs. The LEDs 5 are arranged at an angular distance of thirty degrees between adjacent groups of LEDs. Adjacent groups of LEDs are alternately assigned to a first set 1 and to a second set 2 of LEDs (the reference numerals 1 and 2 of the respective set being shown in the LEDs of the respective group).

FIG. 2 shows a dark-field image DFI of an ophthalmic lens, in the embodiment shown an intraocular lens 10, illuminated by the light source 4 shown in FIG. 1, with all LEDs being simultaneously switched on. The intraocular lens 10 comprises a lens body 11 and two haptics 12, as is well-known in the art. The lens body 11 is bounded by a circumferentially running circular edge 13. Imaging artifacts are shown as white spots which are circularly arranged. The imaging artifacts 14 arranged along the inner circle are so-called first-order imaging artifacts. It is evident from FIG. 1 that the first order imaging artifacts caused by the first set 1 of LEDs and the second set 2 of LEDs do not overlap.

Accordingly, a first dark-field image may be acquired by illuminating the intraocular lens 10 with the aid of the first set 1 of LEDs only (while the LEDs of the second set 2 are switched off), and thereafter a second dark-field image may be acquired with the aid of the second set 2 of LEDs only (while the LEDs of the first set 1 are switched off). A dark-field inspection image may then be generated with the aid of the afore-mentioned first and second dark-field images by setting the brightness value of each pixel of the generated dark-field inspection image to the lowest brightness value of the corresponding pixel of the first and second dark-field images. Thus, it is well possible to generate a dark-field inspection image of the intraocular lens 10 that is free of any first order imaging artifacts.

The imaging artifacts 15 arranged along the outer circle are so-called second order imaging artifacts that generally appear in a region near the edge 13 of the lens body 11 of the intraocular lens 10. As is mentioned further above, these second order imaging artifacts 15 may in particular occur during inspection of an intraocular lens 10 having large diopters (33 D and larger). Again, first and second dark-field images of the intraocular lens 10 may be acquired with the aid of the first set 1 of LEDs and the second set 2 of LEDs in the manner described above. However, different from the first order imaging artifacts 14, the second order imaging artifacts 15 of the first dark-field image and those of the second dark-field image are not free from overlap. In case the dark-field inspection image is then generated as described above, such dark-field inspection image contains areas that may not be properly evaluated for the presence or absence of defects.

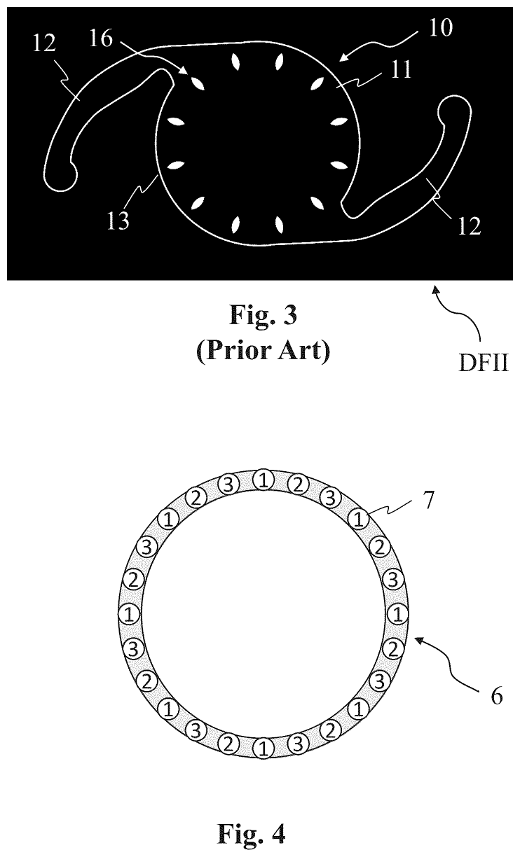

FIG. 3 shows such dark-field inspection image DFII of the intraocular lens 10 which is generated by setting the brightness value of each pixel of the dark-field inspection image to the lowest brightness value of the corresponding pixel of the first and second dark-field images acquired, as described above. Due to the partial overlap of some of the second order imaging artifacts 15, a number of white overlapping areas 16 are present in the dark-field inspection image DFII of the intraocular lens 10. Accordingly, if defects are present in or on the intraocular lens 10 in any of these white overlapping areas 16 and such defects are best visible in a dark-field image, such defects may not be detected here.

FIG. 4 shows an embodiment of a light source 6 which is used in the method and device according to the present. The shown embodiment of the light source 6 comprises twenty-four light emitting elements, in the shown embodiment LEDs 7, which are arranged along a circle at an angular distance of fifteen degrees between adjacently arranged LEDs 7. Each LED 7 is assigned either to a first set 1, or to a second set 2, or to a third set 3 of LEDs 7. The LEDs 7 of the three sets 1, 2, 3, are alternately arranged along the circle. For example, starting with the LED arranged at the twelve o'clock position, this LED is assigned to the first set 1, the next LED in clockwise direction is assigned to the second set 2, and the next LED in clockwise direction is assigned to the third set 3. Thereafter, this sequence starts anew, with the next LED in clockwise direction being again assigned to the first set 1, and so on.

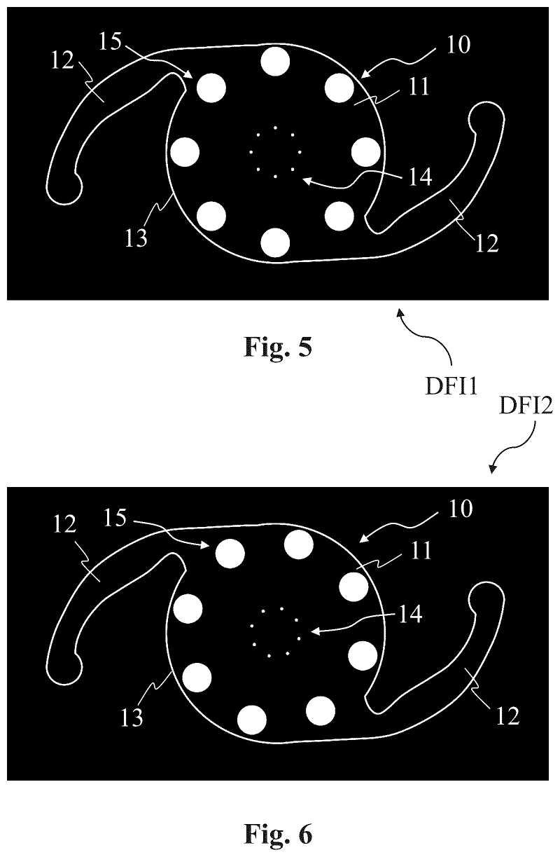

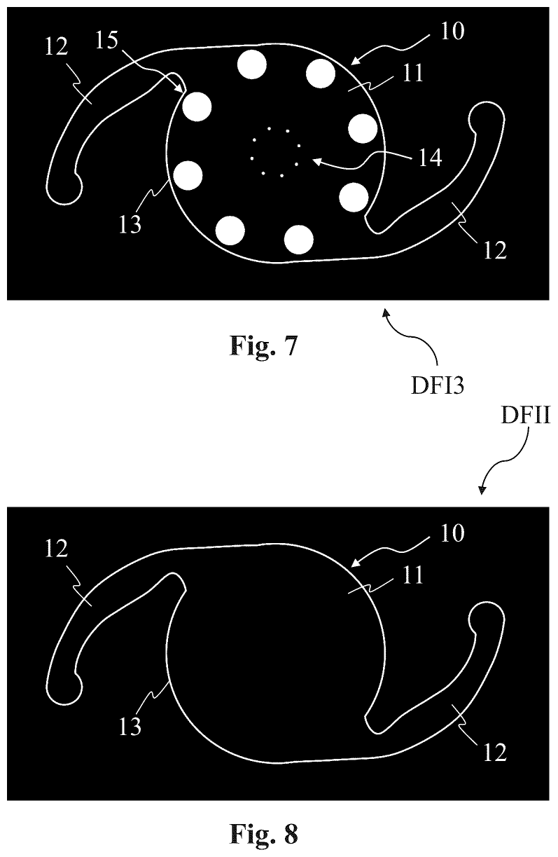

In FIG. 5, FIG. 6 and FIG. 7 a first dark-field image DFI1, a second dark-field image DFI2 and a third dark-field image DFI3 of the ophthalmic lens 10 are shown, with the first dark-field image DFI1 shown in FIG. 5 acquired through illumination of the intraocular lens 10 only by the first set 1 of LEDs 7, the second dark-field image DFI2 acquired through illumination of the intraocular lens 10 by the second set 2 of LEDs 7, and the third dark-field image DFI3 acquired through illumination of the ophthalmic lens 10 by the third set 3 of LEDs 7.

As can be seen from FIG. 5, the first order imaging artifacts 14 and the second order imaging artifacts 15 are visible in the first dark-field image DFI1 of the intraocular lens 10 as white, plain dots or areas, respectively, which are arranged along concentric circles. The second dark-field image DFI2 shown in FIG. 6 and the third dark-field image DFI3 shown FIG. 7 are generally similar, however, the first order imaging artifacts 14 and the second order imaging artifacts 15 are not located in the same regions when comparing the first, second and third dark-field images DFI1, DFI2, DFI3. For example, even though the second order imaging artifact located at twelve o'clock in the first dark-field image DFI 1 (FIG. 5) may partially overlap with the adjacently arranged second order imaging artifact in clockwise direction in the second dark-field image DFI2 (FIG. 6), it does not overlap with the adjacently arranged second order imaging artifact in clockwise direction in the third dark-field image DFI3 (FIG. 7). Thus, at any location of the lens body 11 along the edge 13 of the lens body 11 there is at least one of the first, second and third dark-field images that does not show the second order imaging artifact at that particular location.

A dark-field inspection image DFII of the intraocular lens 10 generated using the method and device of the present disclosure is shown in FIG. 8. For generating this dark-field inspection image DFII, the brightness value of each pixel of the first dark-field image DFI1, the second dark-field image DFI2 and the third dark-field image DFI3 is determined. The determined brightness values of each corresponding pixel of the first dark-field image DFI1, the second dark-field image DFI2 and the third dark-field image DFI3 are then compared, and for each of the corresponding pixels of the first dark-field image DFI1, the second dark-field image DFI2 and the third dark-field image DFI3, a lowest brightness value is determined. The dark-field inspection image DFII is then generated by setting the brightness value of each pixel of the dark-field inspection image DFII to the determined lowest brightness value for that pixel. Since (as explained above in detail) there is always one dark-field image of the first, second and third dark-field images DFI1, DFI2 and DFI3 that does not contain a first order and second order imaging artifact at each location, the first order imaging artifacts 14 and second order imaging artifacts 15 of the first dark-field image DFI1, the second dark-field image DFI2 and the third dark-field image DFI3 are no longer present in the dark-field inspection image DFII (not even partially). Thus, in case the intraocular lens 10 is free of any defects, the dark-field inspection image DFII of such intraocular lens 10 looks like that shown in FIG. 8.

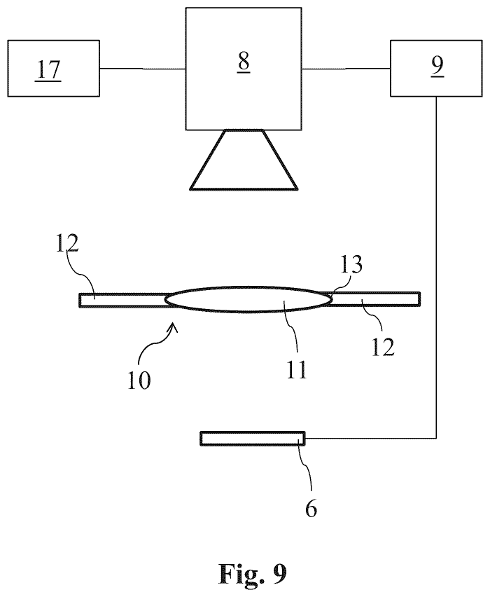

FIG. 9 shows an embodiment of a device for generating a dark-field inspection image DFII of an ophthalmic lens according to the present disclosure, in the embodiment shown the afore-mentioned intraocular lens 10. The device comprises an image acquisition module, in this embodiment a camera 8, for acquiring dark-field images of the intraocular lens 10, which is arranged between the camera 8 and the light source 6. A control unit 9 is connected, either wired or wirelessly, to the camera 8 and the light source 6, and is configured to control the camera 8 to acquire the first dark-field image DFI1, the second dark-field image DFI2 and a third dark-field image DFI3 of the intraocular lens 10. The control unit 9 is further configured to operate only a corresponding different one of the first set 1, the second set 2 and the third set 3, respectively, of the LEDs 7 of the light source 6, to illuminate the ophthalmic lens 10 during acquisition of the first dark-field image DFI1, the second dark-field image DFI2 and the third dark-field image DFI3. The device further comprises an image processing unit 17 which is configured to determine the brightness value of each pixel of the first dark-field image DFI1, the second dark-field image DFI2 and the third dark-field image DFI3, and to compare the determined brightness values of each corresponding pixel of the first dark-field image DFI1, the second dark-field image DFI2 and the third dark-field image DFI3. The image processing unit 17 is further configured to then determine for each of the corresponding pixels of the first dark-field image DFI1, the second dark-field image DFI2 and the third dark-field image DFI3 a lowest brightness value. Finally, the image processing unit 17 is configured to generate the dark-field inspection image DFII by setting the brightness value of each pixel of the dark-field inspection image DFII to the determined lowest brightness value for that pixel, as explained above with respect to the FIGS. 5, 6, 7 and 8.

While embodiments of the present disclosure are described above with the aid of the drawings, it is evident that these embodiments are described by way of example only. The present disclosure is not limited to these embodiments. Only by way of example and without being exhaustive, a number of sets of light emitting elements larger than three is possible as well. Also, a total number of light-emitting elements other than twenty-four is possible. Accordingly, a number of modifications are possible without departing from the teaching underlying the present disclosure. Therefore, the scope of protection is defined by the appended claims.

The present disclosure may also be described in accordance with the following clauses:

Clause 1. A method for generating a dark-field inspection image (DFII) of an ophthalmic lens, the method comprising the steps of:
acquiring at least a first dark-field image (DFI1), a second dark-field image (DFI2), and a third dark-field image (DFI3) of the ophthalmic lens, wherein when acquiring the at least first dark-field image (DFI1), the second dark-field image (DFI2), and the third dark-field image (DFI3), the ophthalmic lens is consecutively illuminated by a corresponding different one of at least a first set (1), a second set (2), and a third set (3), respectively, of light-emitting elements (7) of a light source (6), wherein each light-emitting element (7) of the light source (6) is assigned to only one set of the at least first set (1), the second set (2), and the third set (3) of light-emitting elements (7), and wherein the light-emitting elements (7) are arranged along a circle with an angular distance between two non-adjacently arranged light-emitting elements (7) that is larger than the angular size of imaging artifacts (14, 15) of any of the at least first dark-field image (DFI1), the second dark-field image (DFI2), and the third dark-field image (DFI3), so that imaging artifacts (14, 15) of at least one of the at least first dark-field image (DFI1), the second dark-field image (DFI2), and the third dark-field image (DFI3) do not overlap with imaging artifacts (14, 15) of at least one other dark-field image of the at least first dark-field image (DFI1), the second dark-field image (DFI2), and the third dark-field image (DFI3);
determining a brightness value of each pixel of the at least first dark-field image (DFI1), the second dark-field image (DFI2), and the third dark-field image (DFI3);
comparing the determined brightness value of each corresponding pixel of the at least first dark-field image (DFI1), the second dark-field image (DFI2), and the third dark-field image (DFI3), and determining for each of the corresponding pixels of the at least first dark-field image (DFI1), the second dark-field image (DFI2), and the third dark-field image (DFI3) a lowest brightness value; and
generating the dark-field inspection image (DFII) by setting the brightness value of a respective pixel of the dark-field inspection image (DFII) to a brightness value representative of a dark pixel in case the determined lowest brightness value of a corresponding pixel of any of the at least first dark-field image (DFI1), the second dark-field image (DFI2), and the third dark-field image (DFI3) is representative of a dark pixel, otherwise setting the brightness value of the respective pixel of the dark-field inspection image (DFII) to a brightness value representative of a bright pixel.

Clause 2. The method of clause 1, wherein the angular distance between two non-adjacently arranged light-emitting elements (7) is at least 20°.

Clause 3. The method of clause 1 or clause 2, wherein the brightness value of the respective pixel of the dark-field inspection image (DFII) which is representative of a dark pixel is set to the lowest brightness value determined for the corresponding pixel in any of the at least first dark-field image (DFI1), the second dark-field image (DFI2), and the third dark-field image (DFI3).

Clause 4. The method of any one of clauses 1 to 3, wherein the light-emitting elements (7) of the at least first set (1), the second set (2), and the third set (3) of light-emitting elements (7) are evenly spaced from one another along the circle.

Clause 5. The method of any one of clauses 1 to 4, wherein the light-emitting elements (7) assigned to the at least first set (1), the second set (2), and the third set (3) of light-emitting elements (7) are alternately arranged along the circle, i.e. along the circle each light-emitting element (7) assigned to the first set (1) is followed by a light-emitting element (7) assigned to the second set (2) which is followed by a light-emitting element (7) of the third set (3), and so on.

Clause 6. The method of any one of clauses 1 to 5, wherein the actual number of the at least three dark-field images (DFI1, DFI2, DFI3) is an integer divisor larger than two of the total number of light-emitting elements (7) arranged along the circle.

Clause 7. The method of any one of clauses 1 to 6, wherein the light source (6) comprises a total number of twenty-four light-emitting elements (7) arranged at an angular distance of fifteen degrees between adjacently arranged light-emitting elements (7).

Clause 8. The method of any one of clauses 1 to 7, wherein the ophthalmic lens comprises an intraocular lens (10).

Clause 9. A device for generating a dark-field inspection image (DFII) of an ophthalmic lens, the device comprising:
an image acquisition module (8) for acquiring dark-field images of the ophthalmic lens;
a light source (6) comprising a plurality of light-emitting elements (7) for illuminating the ophthalmic lens, wherein each light-emitting element (7) of the light source (6) is assigned to only one set of at least a first set (1), a second set (2), and a third set (3) of light-emitting elements (7), and wherein the light-emitting elements (7) of the at least first set (1), the second set (2), and the third set (3) of light-emitting elements (7) are arranged along a circle;
a control unit (9) configured to:
   control the image acquisition module (8) to acquire at least a first dark-field image (DFI1), a second dark-field image (DFI2), and a third dark-field image (DFI3) of the ophthalmic lens, wherein, when acquiring a respective one of the at least first dark-field image (DFI1), the second dark-field image (DFI2), and the third dark-field image (DFI3), the control unit (9) is further configured to operate only a corresponding different one of the at least first set (1), the second set (2), and the third set (3), respectively, of the light-emitting elements (7) of the light source (6) to illuminate the ophthalmic lens,
wherein the light-emitting elements (7) are arranged along the circle with an angular distance between two non-adjacently arranged light-emitting elements (7) that is larger than the angular size of imaging artifacts (14, 15) of any of the at least first dark-field image (DFI1), the second dark-field image (DFI2), and the third dark-field image (DFI3), so that imaging artifacts (14, 15) of at least one of the first dark-field image (DFI1), the second dark-field image (DFI2), and the third dark-field image (DFI3) do not overlap with imaging artifacts (14, 15) of at least one other dark-field image of the first dark-field image (DFI1), the second dark-field image (DFI2), and the third dark-field image (DFI3); and
an image processing unit (17) configured to:
   determine a brightness value of each pixel of the at least first dark-field image (DFI1), the second dark-field image (DFI2), and the third dark-field image (DFI3);
   compare the determined brightness value of each corresponding pixel of the at least first dark-field image (DFI1), the second dark-field image (DFI2), and the third dark-field image (DFI3), and determine for each of the corresponding pixels of the first dark-field image (DFI1), the second dark-field image (DFI2), and the third dark-field image (DFI3) a lowest brightness value; and
   generate the dark-field inspection image (DFII) by setting the brightness value of a respective pixel of the dark-field inspection image (DFII) to a brightness value representative of a dark pixel in case the determined lowest brightness value of a corresponding pixel of any of the at least first dark-field image (DFI1), the second dark-field image (DFI2), and the third dark-field image (DFI3) is representative of a dark pixel, otherwise setting the brightness value of the respective pixel of the dark-field inspection image (DFII) to a brightness value representative of a bright pixel.

Clause 10. The device of clause 9, wherein the angular distance between two non-adjacently arranged light-emitting elements (7) is at least 20°.

Clause 11. The device of clause 9 or clause 10, wherein the image processing unit (17) is further configured to set the brightness value of the respective pixel of the dark-field inspection image (DFII) which is representative of a dark pixel to the lowest brightness value determined for the corresponding pixel in any of the at least first dark-field image (DFI1), the second dark-field image (DFI2), and the third dark-field image (DFI3).

Clause 12. The device of any one of clauses 9 to 11, wherein the light-emitting elements (7) of the at least first set (1), the second set (2), and the third set (3) are arranged evenly spaced from one another along the circle.

Clause 13. The device of any one of clauses 9 to 12, wherein the light-emitting elements (7) assigned to the at least first set (1), the second set (2), and the third set (3) of light-emitting elements (7) are alternately arranged along the circle, i.e. along the circle each light-emitting element (7) assigned to the first set (1) is followed by a light-emitting element (7) assigned to the second set (2) which is followed by a light-emitting element (7) of the third set (3), and so on.

Clause 14. The device of any one of clauses 9 to 13, wherein the control unit (9) is configured to control the image acquisition module (8) to acquire an actual number of the at least three dark-field images (DFI1, DFI2, DFI3) which is an integer divisor larger than two of the total number of light-emitting elements (7) arranged along the circle.

Clause 15. The device of any one of clauses 9 to 14, wherein the light source (6) comprises a total number of twenty-four light-emitting elements (7) arranged at an angular distance of fifteen degrees between adjacently arranged light-emitting elements (7).

Clause 16. The device of any one of clauses 9 to 15, wherein the light-emitting elements (7) comprise LEDs, and wherein each light-emitting element (7) comprises a single LED only.

Clause 17. The device of any one of clauses 9 to 16, wherein the ophthalmic lens comprises an intraocular lens (10).

What is claimed is:

1. A method for generating a dark-field inspection image of an ophthalmic lens, the method comprising the steps of:
acquiring at least a first dark-field image, a second dark-field image, and a third dark-field image of the ophthalmic lens, wherein when acquiring the at least first dark-field image, the second dark-field image, and the third dark-field image, the ophthalmic lens is consecutively illuminated by a corresponding different one of at least a first set, a second set, and a third set, respectively, of light-emitting elements of a light source, wherein each light-emitting element of the light source is assigned to only one set of the at least first set, the second set, and the third set of light-emitting elements, and wherein the light-emitting elements are arranged along a circle with an angular distance between two non-adjacently arranged light-emitting elements that is larger than the angular size of imaging artifacts of any of the at least first dark-field image, the second dark-field image, and the third dark-field image, so that imaging artifacts of at least one of the at least first dark-field image, the second dark-field image, and the third dark-field image do not overlap with imaging artifacts of at least one other dark-field image of the at least first dark-field image, the second dark-field image, and the third dark-field image;
determining a brightness value of each pixel of the at least first dark-field image, the second dark-field image, and the third dark-field image;
comparing the determined brightness value of each corresponding pixel of the at least first dark-field image, the second dark-field image, and the third dark-field image, and determining for each of the corresponding pixels of the at least first dark-field image, the second dark-field image, and the third dark-field image a lowest brightness value; and
generating the dark-field inspection image by setting the brightness value of a respective pixel of the dark-field inspection image to a brightness value representative of a dark pixel in case the determined lowest brightness value of a corresponding pixel of any of the at least first dark-field image, the second dark-field image, and the third dark-field image is representative of a dark pixel, otherwise setting the brightness value of the respective pixel of the dark-field inspection image to a brightness value representative of a bright pixel.

2. The method of claim 1, wherein the angular distance between two non-adjacently arranged light-emitting elements is at least 20°.

3. The method of claim 1, wherein the brightness value of the respective pixel of the dark-field inspection image which is representative of a dark pixel is set to the lowest brightness value determined for the corresponding pixel in any of the at least first dark-field image, the second dark-field image, and the third dark-field image.

4. The method of claim 1, wherein the light-emitting elements of the at least first set, the second set, and the third set of light-emitting elements are evenly spaced from one another along the circle.

5. The method of claim 1, wherein the light-emitting elements assigned to the at least first set, the second set, and the third set of light-emitting elements are alternately arranged along the circle, i.e. along the circle each light-emitting element assigned to the first set is followed by a light-emitting element assigned to the second set which is followed by a light-emitting element of the third set, and so on.

6. The method of claim 1, wherein the actual number of the at least three dark-field images is an integer divisor larger than two of the total number of light-emitting elements arranged along the circle.

7. The method of claim 1, wherein the light source comprises a total number of twenty-four light-emitting elements arranged at an angular distance of fifteen degrees between adjacently arranged light-emitting elements.

8. The method of claim 1, wherein the ophthalmic lens comprises an intraocular lens.

9. A device for generating a dark-field inspection image of an ophthalmic lens, the device comprising:
an image acquisition module for acquiring dark-field images of the ophthalmic lens;
a light source comprising a plurality of light-emitting elements for illuminating the ophthalmic lens, wherein each light-emitting element of the light source is assigned to only one set of at least a first set, a second set, and a third set of light-emitting elements, and wherein the light-emitting elements of the at least first set, the second set, and the third set of light-emitting elements are arranged along a circle;
a control unit configured to:
control the image acquisition module to acquire at least a first dark-field image, a second dark-field image, and a third dark-field image of the ophthalmic lens, wherein, when acquiring a respective one of the at least first dark-field image, the second dark-field image, and the third dark-field image, the control unit is further configured to operate only a corresponding different one of the at least first set, the second set, and the third set, respectively, of the light-emitting elements of the light source to illuminate the ophthalmic lens,
wherein the light-emitting elements are arranged along the circle with an angular distance between two non-adjacently arranged light-emitting elements that is larger than the angular size of imaging artifacts of any of the at least first dark-field image, the second dark-field image, and the third dark-field image, so that imaging artifacts of at least one of the first dark-field image, the second dark-field image, and the third dark-field image do not overlap with imaging artifacts of at least one other dark-field image of the first dark-field image, the second dark-field image, and the third dark-field image; and
an image processing unit configured to:
determine a brightness value of each pixel of the at least first dark-field image, the second dark-field image, and the third dark-field image;
compare the determined brightness value of each corresponding pixel of the at least first dark-field image, the second dark-field image, and the third dark-field image, and determine for each of the corresponding pixels of the first dark-field image, the second dark-field image, and the third dark-field image a lowest brightness value; and
generate the dark-field inspection image by setting the brightness value of a respective pixel of the dark-field inspection image to a brightness value representative of a dark pixel in case the determined lowest brightness value of a corresponding pixel of any of the at least first dark-field image, the second dark-field image, and the third dark-field image is representative of a dark pixel, otherwise setting the brightness value of the respective pixel of the dark-field inspection image to a brightness value representative of a bright pixel.

10. The device of claim 9, wherein the angular distance between two non-adjacently arranged light-emitting elements is at least 20°.

11. The device of claim 9, wherein the image processing unit is further configured to set the brightness value of the respective pixel of the dark-field inspection image which is representative of a dark pixel to the lowest brightness value determined for the corresponding pixel in any of the at least first dark-field image, the second dark-field image, and the third dark-field image.

12. The device of claim 9, wherein the light-emitting elements of the at least first set, the second set, and the third set are arranged evenly spaced from one another along the circle.

13. The device of claim 9, wherein the light-emitting elements assigned to the at least first set, the second set, and the third set of light-emitting elements are alternately arranged along the circle, i.e. along the circle each light-emitting element assigned to the first set is followed by a light-emitting element assigned to the second set which is followed by a light-emitting element of the third set, and so on.

14. The device of claim 9, wherein the control unit is configured to control the image acquisition module to acquire an actual number of the at least three dark-field images which is an integer divisor larger than two of the total number of light-emitting elements arranged along the circle.

15. The device of claim 9, wherein the light source comprises a total number of twenty-four light-emitting elements arranged at an angular distance of fifteen degrees between adjacently arranged light-emitting elements.

16. The device of claim 9, wherein the light-emitting elements comprise LEDs, and wherein each light-emitting element comprises a single LED only.

17. The device of claim 9, wherein the ophthalmic lens comprises an intraocular lens.
